(19) United States
(12) Patent Application Publication
(10) Pub. No.: US 2026/0246804 A1
(43) Pub. Date: Aug. 20, 2026

(54) SYSTEM AND METHOD FOR DETERMINING SECURITY GAPS AND RANKING RECOMMENDATIONS TO ADDRESS THE SECURITY GAPS

(71) Applicant: Vega Cyber Solutions LTD, Tel Aviv Yafo (IL)

(72) Inventors: Eran LILOOF, Tel Aviv (IL); Eli ROZEN, Tel Aviv (IL); Shay SANDLER, Tel Aviv (IL); Tomer COHEN, Tel Aviv (IL); Elior GITELMAN, Tel Aviv (IL)

(73) Assignee: Vega Cyber Solutions LTD, Tel Aviv Yafo (IL)

(21) Appl. No.: 19/057,529

(22) Filed: Feb. 19, 2025

(51) Int. Cl. H04L 9/40

(52) U.S. Cl. CPC H04L 63/1433

(57) ABSTRACT

A system and method for identifying security gaps in a cybersecurity system is provided. The method includes retrieving a plurality of data sources from each of a plurality of data lakes, wherein the plurality of data sources includes data from a plurality of domains of an organization’s information technology infrastructure; identifying security gaps in the cybersecurity system by analyzing the plurality of data sources, wherein security gaps indicate at least one uncovered deficiency in the cybersecurity system; and generating at least one recommendation, wherein each recommendation is a suggestion to address a respective identified security gap.

### TECHNICAL FIELD

The present disclosure generally relates to cyber-security technologies and, more specifically, to make improvements to SIEM tools.

### BACKGROUND

Security Information and Event Management (SIEM) tools are critical components in cybersecurity that provide real-time analysis and monitoring of security alerts generated by network hardware and applications. Such tools are designed to help organizations detect, analyze, and respond to security threats more effectively. SIEM tools consolidate and correlate data from various sources to provide a unified view of an organization's security posture, security threats, and the like.

Currently, available SIEM tools provide some functionality, such as log management, real-time monitoring and alerts, threat detection (based on analysis of log data), incident response, compliance reporting, and forensics.

Different vendors provide different tools, each of which may implement a subset of the functions mentioned above. Examples of popular SIEM tools include Splunk® Enterprise Security (providing analytics capabilities), IBM® QRadar (providing correlation to detect threats), ArcSight by Micro Focus, LogRhythm (providing real-time threat detection and response capabilities), AlienVault (providing integrated threat intelligence capabilities), and Microsoft® Sentinel (providing a cloud-native SIEM and SOAR (Security Orchestration, Automation, and Response) solution).

Additionally, SIEM tools may consolidate data from various sources in data lakes. A data lake is a centralized repository that stores vast amounts of raw data in its native format, including structured, semi-structured, and unstructured data. In cybersecurity, data lakes are crucial because they consolidate security-related data from various sources, enabling comprehensive analysis and a unified view of an organization's security posture, ultimately enhancing the overall security of the organization.

However, SIEM tools face certain challenges as well. One significant problem is their inability to detect security gaps indicated by a lack of data logs or low-quality logs. If certain logs are not being collected or are missing, the SIEM tool may not have a complete picture of the organization's security environment. This can lead to undetected vulnerabilities and potential security gaps, as the tool relies heavily on the data it receives to identify threats.

Another issue with SIEM tools is their lack of ability to prioritize recommendations for security improvements. While SIEM tools can generate alerts and identify potential threats, they often do not provide guidance on which security improvements would offer the highest value at the lowest cost. This makes it challenging for organizations to make informed decisions about where to allocate resources for optimal security enhancements. Without this prioritization, organizations may struggle to implement the most effective security measures in a cost-efficient manner.

It would, therefore, be advantageous to provide a solution that would overcome the challenges noted above.

### SUMMARY

A summary of several example embodiments of the disclosure follows. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include retrieving a plurality of data sources from each of a plurality of data lakes, where the plurality of data sources includes data from a plurality of domains of an organization’s information technology infrastructure. The method may also include identifying security gaps in the cybersecurity system by analyzing the plurality of data sources, where security gaps indicate at least one uncovered deficiency in the cybersecurity system. The method may furthermore include generating at least one recommendation, where each recommendation is a suggestion to address a respective identified security gap. Other embodiments of this aspect include corresponding computer systems, apparatus, and computer programs recorded on one or more computer storage devices, each configured to perform the actions of the methods.

Implementations may include one or more of the following features. The method may include: connecting to the plurality of data lakes, where each data lake is a repository of raw data from the plurality of data sources. The method where identifying the security gaps further may include: identifying at least one missing data source; identifying security issues; determining quality of data recorded in the plurality of data sources; and analyzing the at least one missing data source, the identified security issues, and the determined quality of data to identify security gaps. The method where identifying at least one missing data source further may include: comparing collected data sources of the plurality of data sources with historical data sources to determine at least one previously collected data source that is now missing where the determined missing data source indicates at least one uncovered deficiency that can be exploited. The method where identifying the security issues further may include: analyzing patterns in the historical data sources, where a security issue indicates a blind spot that hinders the capability to identify a potential incident. The method where determining the quality of data further may include: analyzing the number of fields in a data log, the formats of different data logs, and the level of detail in the data logs to determine missing critical information that indicates at least a potential cyber-attack. The method where collected data sources are data sources that are currently collected by an organization and stored in at least one data lake of the plurality of data lakes; and where historical data sources are data sources that previously were collected by an organization and stored in at least one data lake of the plurality of data lakes. The method may include: ranking the at least one recommendation, where each recommendation is ranked based on a security value and an ease-of-implementation value. The method where the security value is a measure of how valuable a recommendation of the at least one recommendation is for the cyber-security of an organization; and where the ease-of-implementation value is a measure of the facility, efficiency, cost, and time associated with implementation of a recommendation of the at least one recommendation. The method where a domain of the plurality of domains is any one of: a network domain, a cloud domain, an identity domain, an application domain, and an endpoint domain. Implementations of the described techniques may include hardware, a method or process, or a computer tangible medium.

In one general aspect, a non-transitory computer-readable medium may include one or more instructions that, when executed by one or more processors of a device, cause the device to: retrieve a plurality of data sources from each of a plurality of data lakes, where the plurality of data sources includes data from a plurality of domains of an organization’s information technology infrastructure; identify security gaps in the cybersecurity system by analyzing the plurality of data sources, where security gaps indicate at least one uncovered deficiency in the cybersecurity system; and generate at least one recommendation, where each recommendation is a suggestion to address a respective identified security gap. Other embodiments of this aspect include corresponding computer systems, apparatus, and computer programs recorded on one or more computer storage devices, each configured to perform the actions of the methods.

Implementations may include one or more of the following features. A system where the one or more processors are further configured to: connect to the plurality of data lakes, where each data lake is a repository of raw data from the plurality of data sources. The system where the one or more processors, when identifying at least one missing data source, are configured to: compare collected data sources of the plurality of data sources with historical data sources to determine at least one previously collected data source that is now missing where the determined missing data source indicates at least one uncovered deficiency that can be exploited. The system where the one or more processors, when identifying the security issues, are configured to: analyze patterns in the historical data sources, where a security issue indicates a blind spot that hinders the capability to identify a potential incident. The system where the one or more processors, when determining the quality of data, are configured to: analyze the number of fields in a data log, the formats of different data logs, and the level of detail in the data logs to determine missing critical information that indicates at least a potential cyber-attack. The system where collected data sources are data sources that are currently collected by an organization and stored in at least one data lake of the plurality of data lakes; and where historical data sources are data sources that previously were collected by an organization and stored in at least one data lake of the plurality of data lakes. The system where the security value is a measure of how valuable a recommendation of the at least one recommendation is for the cyber-security of an organization; and where the ease-of-implementation value is a measure of the facility, efficiency, cost, and time associated with implementation of a recommendation of the at least one recommendation. The system where the one or more processors are further configured to: rank the at least one recommendation, where each recommendation is ranked based on a security value and an ease-of-implementation value. The system where a domain of the plurality of domains is any one of: a network domain, a cloud domain, an identity domain, an application domain, and an endpoint domain. Implementations of the described techniques may include hardware, a method or process, or a computer tangible medium.

In one general aspect, the system may include one or more processors configured to: retrieve a plurality of data sources from each of a plurality of data lakes, where the plurality of data sources includes data from a plurality of domains of an organization’s information technology infrastructure; identify security gaps in the cybersecurity system by analyzing the plurality of data sources, where security gaps indicate at least one uncovered deficiency in the cybersecurity system; generate at least one recommendation, where each recommendation is a suggestion to address a respective identified security gap. Other embodiments of this aspect include corresponding computer systems, apparatus, and computer programs recorded on one or more computer storage devices, each configured to perform the actions of the methods.

Implementations may include one or more of the following features. The system where the one or more processors, when identifying the security gaps, are configured to: identify at least one missing data source; identify security issues; determine quality of data recorded in the plurality of data sources; and analyze the at least one missing data source, the identified security issues, and the determined quality of data to identify security gaps. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows an example network diagram utilized to describe the various disclosed embodiments.

FIG. 2 shows an example diagram demonstrating the operation of a system executing analysis of security gaps according to disclosed embodiments.

FIG. 3 is an example flowchart demonstrating an example process for identifying security gaps and ranking recommendations that address the security gaps according to an embodiment.

FIG. 4 is an example flowchart of a process for determining security gaps according to an embodiment.

FIG. 5 is an example graph 500 of ranked recommendations for addressing security gaps in an organization’s security system according to an embodiment.

FIG. 6. is an example schematic diagram of a system according to an embodiment.

### DETAILED DESCRIPTION

The various disclosed embodiments include a method and system for identifying security gaps in security systems of an organization and generating ranked recommendations based on each identified security gap. The disclosed system may be configured to analyze a plurality of data sources in data lakes to identify security gaps in an organization protected by the disclosed system. The disclosed system may be configured to connect to data lakes to identify security gaps in an organization’s security system. The disclosed system is further configured to identify security gaps in an organization’s security system based on a comparison of the identified data sources of the data lakes and known data sources used historically by the organization as well as the quality of the identified data sources in the data lakes.

The disclosed system provides a security gap analyzer that is configured to connect to a plurality of data lakes. These data lakes are large, centralized repositories of raw data that include sets of logs and other data sources that record cyber events in a networking environment. The networking environment is a comprehensive system designed to facilitate communication and data exchange among various interconnected devices and resources. This environment may include both physical (e.g., servers, routers, switches, and storage devices) and virtual entities (virtual machines (VMs), virtual networks, virtual storage, and software containers), which may be deployed on-premises or within a cloud computing infrastructure. The security gap analyzer is configured to analyze sets of data sources recorded in the data lakes to determine what data sources are missing from the data lake, revealing security gaps in the organization's security systems. The security gap analyzer performs this determination by analyzing an archive of data sources used in data lakes by an organization and comparing that archive to currently used data sources. The security gap analyzer is also configured to determine which data sources are partially available to the organization, revealing that the data sources, e.g. logs, may be useless, irrelevant, or lacking information concerning cyber-events.

In this regard, it is recognized that a human can manually analyze each data source of each data lake to identify security gaps and generate ranked recommendations. However, this would require the user (human) to apply subjective criteria to determine security gaps in each data source and to determine the recommendations as well as the rankings for the recommendations. Furthermore, different users may apply different subjective criteria, resulting in even more disparity in the identified security gaps and the ranked recommendations. The disclosed system solves this, in an embodiment, by at least applying predefined objective criteria to identify security gaps and rank recommendations, thus generating reliably consistent results.

Furthermore, the disclosed system improves the security of the organization by providing a more comprehensive view of an organization’s security environment and allows a user (e.g., a security researcher) to augment the organization’s security systems with prioritized recommendations to address identified security gaps. These gaps indicate potential weaknesses or uncovered issues (or deficiencies) through which an attack may go undetected if such security gaps and recommendations are not identified. Additionally, the disclosed system allows the security researcher to prioritize certain improvements over others based on security value and cost (in data, resource usage, time, and effort).

Moreover, due to the high volume of events, logs, and incidents (hereinafter “data sources”) that data lakes report, it is impossible for a human to review and analyze all data sources with multiple tools and identify security gaps in real-time. As such, a hacker can exploit a cybersecurity weakness, which is why speed is of the essence.

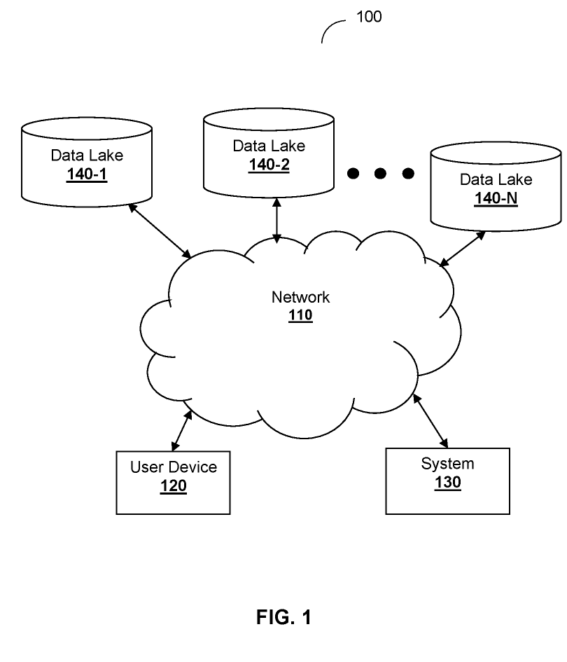

FIG. 1 shows an example network diagram 100 utilized to describe the various disclosed embodiments. In the example network diagram 100, a user device 120, system 130, and a plurality of data lakes 140-1 through 140-N (hereinafter referred to individually as a data lake 140 and collectively as data lakes 140, for simplicity purposes) communicate via a network 110. Network 110 may be but is not limited to, a wireless, cellular, or wired network, a local area network (LAN), a wide area network (WAN), a metro area network (MAN), the Internet, the World Wide Web (WWW), similar networks, or any combination thereof. The data lakes 140 may be deployed in a cloud computing platform.

The user device (UD) 120 may be but is not limited to, a personal computer, a laptop, a tablet computer, a smartphone, a wearable computing device, or any other device capable of receiving and displaying notifications. The user device 120 may receive intermediate or final reports on security gap analysis and ranked recommendations from system 130.

Data lakes 140 may store logs from various sources like firewalls, servers, applications, and network devices in an organization protected by system 130. Data lakes 140 may further store or provide detailed reports and data for forensic analysis and/or alerts on cyber incidents. A data lake 140 may include but is not limited to, SIEM tools, data storage devices, and the like. Examples of data lakes 140 include SIEM tools, such as Splunk® Enterprise Security, ArcSight by Micro Focus, LogRhythm, AlienVault, Microsoft® Sentinel, and the like. A data lake 140 may be realized as a centralized repository for storing structured and unstructured data at any scale. Unlike traditional databases that store data in structured formats, a data lake 140 can store raw data, which can be processed later according to different needs. The cyber data stored in a data lake may include logs, incidents, and the like. A data lake 140 may be a storage, such as a database including structured data, a cloud storage, or the like.

Each data lake of the data lakes 140 may be provided by different vendors and, as such, may store different types of data in different formats. Further, data lakes 140 can be connected and accessed differently. For example, some data lakes may be queried with SQL, some data lakes may be queried with a priority query language, and some data lakes may be accessed and queried via API.

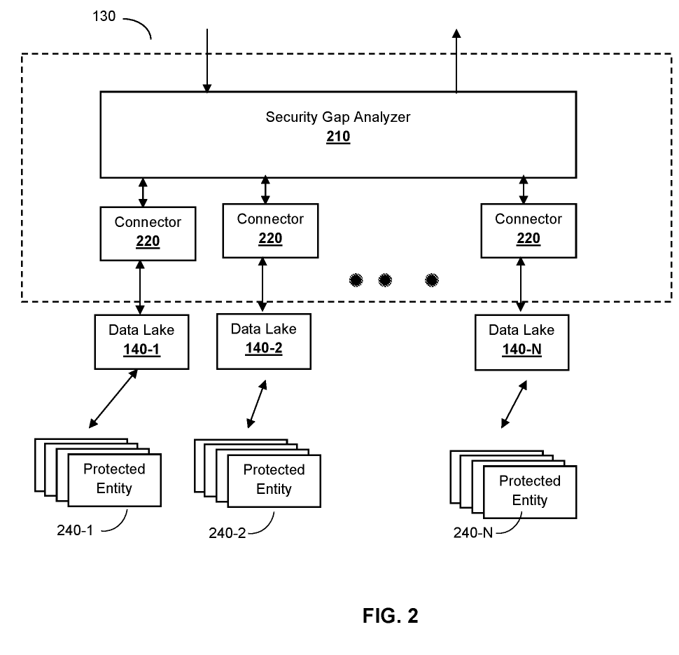

System 130 may include a plurality of connectors (shown in FIG. 2). Each connector allows connection with a target data lake 140 according to a protocol and/or query language implemented by the data lake.

It should be noted that system 130 can be deployed either in the cloud computing environment or on-premises, depending on the organization's needs, resources, and preferences. The cloud computing environment can be a public, private, or hybrid cloud. Examples of public cloud computing environments include Amazon® Web Services (AWS), Microsoft® Azure, or Google® Cloud Platform (GCP), which offer shared infrastructure managed by the cloud provider, providing scalability, flexibility, and reduced infrastructure management. On-premises deployment involves hosting system 130 on the organization's servers and infrastructure, giving the organization complete control over the environment but also requiring more management and maintenance effort. This option is often chosen for systems with strict security or compliance requirements.

It should be understood that the embodiments described herein are not limited to the specific arrangement illustrated in FIG. 1, and other arrangements may be equally used without departing from the scope of the disclosed embodiments.

FIG. 2 shows an example diagram demonstrating the operation of system 130 performing the identification of security gaps and generation of ranked recommendations to address the security gaps. As illustrated in FIG. 2, system 130 includes a security gap analyzer 210 (or simply “gap analyzer” 210) and a plurality of connectors 220. Each connector 220 provides connectivity to a data lake 140. A connector 220 allows querying or providing API requests to the respective data lake 140 according to the protocol implemented by the data lake 140.

As noted above, a data lake 140 may include an SIEM tool, a storage device, a database, and the like. Different vendors may provide data lakes 140, and as such, data in one data lake may be saved, indexed, maintained, or retrieved in a different way. For example, a data lake 140 may include a Splunk® SIEM, which can be queried using a proprietary query language known as SPL. The SPL is defined and operated differently than an SQL.

According to the disclosed embodiments, connectors 220 are designed to interface between an input query entered by a user and the proprietary protocol implemented by the respective data lake 140. The input query may be in an SQL or natural language.

A protected entity (collectively labeled as 240) may be deployed in a cloud computing environment or on-premises. Furthermore, it may be a physical or virtual entity. Examples of protected entities include virtual machines (VMs), virtual networks, virtual storage, containers, firewalls, load balancers, servers, databases (physical and virtual), end-point devices, and so on.

According to the disclosed embodiments, a user may select a set of target data lakes 140 to connect to. To this end, gap analyzer 210 instantiates respective connectors 220 associated with the selected data lake 140. The connection between a connector 220 and a data lake 140 would require the credentials of the data lake 140.

Gap analyzer 210 is configured to analyze each data lake used in an organization’s security system. Analyzing the data sources in each data lake to determine whether and which data sources are missing or only include partial information of incidents and events serves to identify security gaps, e.g. vulnerabilities, in the organization’s security system.

Gap analyzer 210 connects to the data lakes 140 through respective connectors 220. Gap analyzer 210, by analyzing the data logs of the each data lake 140, identifies historical data sources used in the security system of an organization. Based on these historical data sources, the gap analyzer 210 identifies the absence of certain data logs and the quality of the logs themselves to identify security gaps in the security system of an organization. According to an embodiment, a security gap in a security system may be indicated by the absence of logs from a particular data source that is historically gathered by the organization. A security gap in a security system may also be indicated by the lack of detail in the information recorded in one or more logs.

It should be noted that connectors 220 may be realized in software, firmware, hardware, or a combination thereof. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by a processing circuitry, cause the processing circuitry to operate the connector.

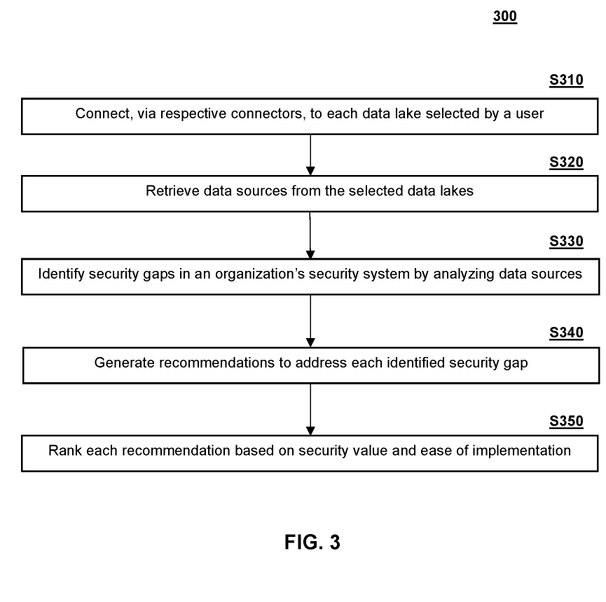

FIG. 3 is an example flowchart of an example process 300 for identifying security gaps in an organization’s security system and ranking recommendations to address identified security gaps. In some implementations, one or more process blocks of FIG. 3 may be performed by the system 130.

At S310, each data lake selected by a user is connected to. In an embodiment, each respective connector is configured to connect, for example, the gap analyzer 210 to a respective data lake. Connecting to each data lake allows the gap analyzer 210 to retrieve the events, logs, and incidents (data sources) gathered in each data lake and analyze the data sources.

At S320, data sources from the selected data lakes are retrieved. In an embodiment, this retrieval is performed by connecting to each data lake via a respective connector.

In an embodiment, the data from each data source of each data lake is categorized into different domains based on the layer of the organization’s information technology infrastructure the data is associated with. Domains may include network, identity, endpoint, application, and cloud. The network domain includes all data related to network traffic, such as logs from firewalls, routers, and switches. The identity domain encompasses data related to user identities and access management, including authentication logs and user activity records. The endpoint domain covers data from endpoint devices like computers, mobile devices, and IoT devices, including antivirus logs and device activity. The application domain includes data generated by software applications, including application logs, error reports, and user interactions. The cloud domain includes data from cloud services and infrastructure, such as logs from cloud-based applications, virtual machines, and storage services.

At S330, security gaps in an organization’s security system are identified by analyzing data sources. A security gap refers to a weakness or an uncovered deficiency in an organization's security measures that could potentially be exploited by a threat actor. Security gaps indicate where security controls are insufficient or missing, leaving the organization exposed to potential risks.

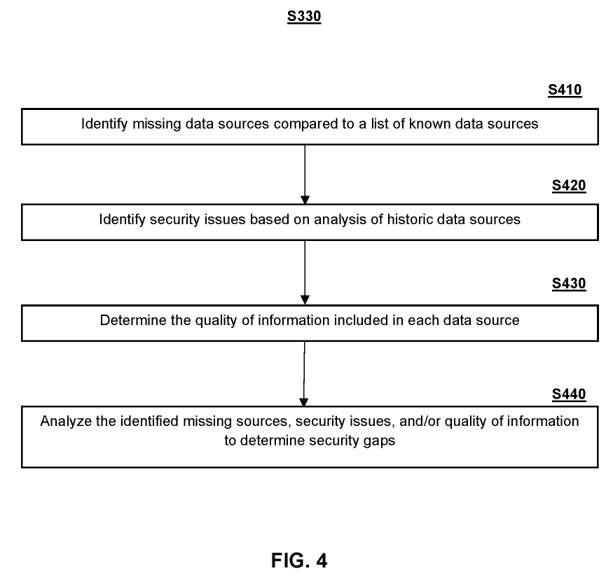

In an embodiment, within each domain, data sources that are missing, available, and partially available are identified based on a comparison with known data sources of each data lake. The process of determining security gaps is discussed in more detail in FIG. 4.

A data source is considered available if the relevant data lake gathers sufficient information regarding events, logs, and incidents for that data source. A data source is considered missing if the relevant data lake does not gather any information regarding events, logs, and incidents for that data source. A data source is considered partially available if the relevant data lake gathers insufficient information regarding events, logs, and incidents for that data source. The presence, absence, or sufficiency of information associated with a data source is determined through a comparative analysis of known data sources collected by each data lake and data sources currently collected by each data lake.

As a non-limiting example, an organization’s retrieved data sources associated with an identity domain are analyzed to identify any gaps in an organization’s security system. Both live and historical data sources may be retrieved from a plurality of data lakes that are associated with the identity domain. These data sources may include but are not limited to, logs associated with Identity and Access Management (IAM) services, authentication service providers, Virtual Private Network (VPN) logins, identity management software providers, privileged access management (PAM) solutions, Windows logs®, Linux® logs, and the like. In an embodiment, it may be determined, after an analysis of the retrieved data sources, that an organization’s data lakes have successfully collected logs regarding identity management activities, logs regarding VPN authentication (revealing details into remote access attempts), PAM server logs, and other strengths in security. It may also be determined that an organization has only partially available information from certain data sources associated with the identity domain. For example, the analysis may reveal that directory-based identity-related services are restricted to logs from only a subset of a set of domain controllers, which indicates a lack of comprehensive logs for monitoring authentication activities. Additionally, an absence of server-level authentication logs for Windows® and Linux® operating systems may be detected. The partial availability of some logs and the absence of others indicate a security gap in the organization’s systems. The system may not be able to detect an attacker who gains unauthorized access through domain credential theft, escalates privileges, or moves laterally with the network without triggering alerts.

As another non-limiting example, an organization’s retrieved data sources associated with a network domain are analyzed to identify any gaps in an organization’s security system. Both live and historical data sources may be retrieved from a plurality of data lakes that are associated with the network domain. These data sources may include but are not limited to, logs associated with Cloud Security Platforms, Firewalls, Network Switches, Intrusion Detection Systems (IDS), Load Balancers (LB), Web Application Firewalls (WAF), Domain Name Systems (DNS), Network Access Controls (NAC), and Dynamic Host Configuration Protocols (DHCP). In an embodiment, it may be determined, after an analysis of the retrieved data sources, that comprehensive firewall logging is in place.

It may also be determined that an organization collects logs for monitoring and identifying malicious domain communications from only one data source, creating a single point of failure for this function. Further, it may be determined that the data lakes do not collect IDS logs, limiting visibility into internal network traffic patterns of the organization and leaving blind spots to potential threats. Additionally, an absence of WAF and LB logs may be detected, indicating a lack of visibility into incoming web traffic. Given missing or partially available data sources collected by the data lakes of the organization, it may be determined that there is a security gap in the organization’s systems. For example, the organization’s web applications may be vulnerable to exploitation, allowing attackers to gain unauthorized access, move between systems undetected, and exfiltrate data without triggering alerts.

As another non-limiting example, an organization’s retrieved data sources associated with an endpoint domain are analyzed to identify any gaps in an organization’s security system. Both live and historical data sources may be retrieved from a plurality of data lakes that are associated with the endpoint domain. These data sources may include but are not limited to, logs associated with Endpoint Detection and Response (EDR) service, hypervisors, personal computers, domain controllers event logs, Windows® Event logs, scripting activity logs, backup process data logs, and Linux logs.

In an embodiment, it may be determined, after an analysis of the retrieved data sources, that the organization’s EDR deploys many agents to provide endpoint security to devices and servers, and Windows® Event logs capture high-value event IDs. It may also be determined that the Windows® Event logs are restricted to a subset of a set of domain controllers, scripting activity logs are not collected, and only one service provider is used for endpoint security (which creates a single point of failure for a critical dataset.) Given missing or partially available data sources collected by the data lakes of the organization, it may be determined that there is a security gap in the organization’s systems. Attackers may, for example, compromise credentials and move laterally; execute malicious scripts, leading to data exfiltration, ransomware deployment, or long-term persistence without raising alarms; and compromise an endpoint or bypass an EDR agent.

As another non-limiting example, an organization’s retrieved data sources associated with a cloud domain are analyzed to identify any gaps in an organization’s security system. Both live and historical data sources may be retrieved from a plurality of data lakes that are associated with the cloud domain. These data sources may include, but are not limited to, logs associated with Cloud Security Platforms, Platform Activity Logs, Audit Logging Services, Network Flow Logs, Threat Detection Services, and Monitoring Alerts. In an embodiment, it may be determined, after an analysis of the retrieved data sources, that Platform Activity logs are successfully collected in the organization’s data lakes. It may also be determined that Cloud Security Platforms and Platform Activity Logs are not triggering alerts, and Network Flow Logs are absent or not successfully collected in the data lakes of the organization. Given missing or partially available data sources collected by the data lakes of the organization, it may be determined that there is a security gap in the organization’s systems. Attackers may, for example, exfiltrate data undetected without triggering alerts.

As another non-limiting example, an organization’s retrieved data sources associated with an application domain are analyzed to identify any gaps in an organization’s security system. Both live and historical data sources may be retrieved from a plurality of data lakes that are associated with the application domain. These data sources may include but are not limited to, logs associated with Productivity Suites (e.g., Microsoft 365®, Web Services, Application Programming Interfaces (APIs), Application Delivery Controllers (ADC), source control platforms, databases, backups, password managers, and Software-as-a-Service (SaaS) applications. In an embodiment, it may be determined, after an analysis of the retrieved data sources, that Microsoft® cloud suite logs and Microsoft Defender® are successfully collected in the data lakes of the organization and backup logs provide visibility into cloud backup operations. It may also be determined that Web and API access logs are not collected, ADC logs lack sufficient detail on access information, source control logs are absent, and database logs are limited to one server.

Given missing or partially available data sources collected by the data lakes of the organization, it may be determined that there is a security gap in the organization’s systems. Attackers may, for example, gain undetected and unauthorized initial access to systems. The organization is vulnerable to insider threats, including from former employees of the organization, due to Single Sign-On not being in place. Missing database logs increases the risk of undetected data tampering or exfiltration. The lack of Kubernetes® logs leaves container orchestration environments vulnerable to exploitation without triggering alerts. Additionally, the absence of source control logs increases the risk of undetected compromised codebases. Further, insufficient backup logs increase the chance of attacks tampering with backups to exfiltrate data.

In an embodiment, the historical analysis to determine security gaps is performed through the use of an AI model. A prompt may be configured for an AI model that includes data from the retrieved data sources, including archived data sources, from the data lake and a task to identify which data sources are no longer collected by each data lake and which data sources are lacking information that was previously available in the data sources. The prompt may be configured to input data sources that are an appropriate size (e.g., context size) for an AI model to be able to perform the analysis without being overwhelmed with too much data. The results, having been processed by the AI model, include identified security gaps. According to this embodiment, a security researcher is able to send follow-up prompts to the AI model based on the initial output that includes the security gaps.

The AI model that may be utilized for the analysis is a large language model (LLM). The LLM used or prompted may include any of the following: GPT-3, GPT-4, T5 BART, FLAN-T5, LLaMA, LaMDA, PaLM, Bloom, and the like.

At S340, recommendations are generated to address each identified security gap. Recommendations are suggestions including, but not limited to, retrieving logs for the missing data sources or increasing the quality, e.g., level of detail, of the retrieved logs for partially available data sources.

At S350, each recommendation is ranked based on the security value and ease of implementing each recommendation. Security value is a measure of how valuable the recommendation is for the cyber-security of the organization. A first recommendation with a higher security value than the security value of a second recommendation means that implementing the first recommendation would serve to improve the organization’s security posture more than implementing the second recommendation. Ease of implementation is a measure of the facility, efficiency, cost, time, and the like, of implementing the recommendation. A first recommendation with a higher ease of implementation than a second recommendation with a lower ease of implementation means that implementing the first recommendation requires, for example, less computer resource usage, less data, less human input, and less time, but is not limited to the aforementioned examples.

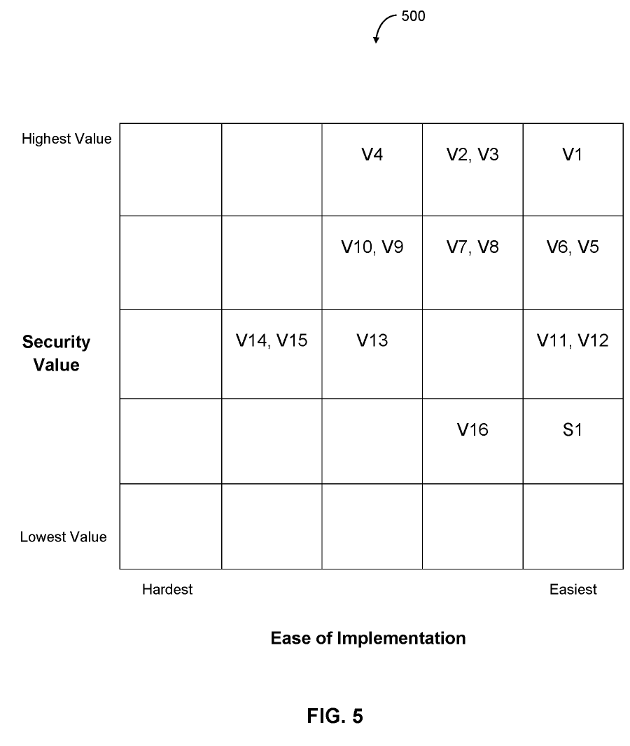

In an embodiment, the ranking of recommendations includes generating a graph that depicts the hierarchy of recommendations on two axes: security value and ease of implementation. Recommendations with the highest security value and the highest ease of implementation are prioritized in the hierarchy. The graphical representation of ranked recommendations is shown in detail in FIG. 5.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

FIG. 4 is an example flowchart S330 of a process for determining security gaps according to an embodiment. In some implementations, one or more process blocks of FIG. 4 may be performed by the gap analyzer 210 of system 130.

At S410, missing data sources, compared to a list of known data sources, are identified. Known data sources are identified based on an analysis of historical data sources. Known data sources are data sources that a data lake of an organization previously (historically) collected. Compared to the known data sources, certain data sources may be identified as missing when those data sources are not collected by a data lake (and previously were collected).

At S420, security issues are identified based on an analysis of historical data sources of each data lake. Through this analysis, security issues are identified based on patterns shown in the historical data sources. This historical analysis of security issues serves to allow more accurate identification of security gaps.

A security issue is defined as an event or incident where the cyber-security of an organization has been compromised. This could be, but is not limited to, a data breach, malware infection, or unauthorized access to systems. A security issue indicates that a threat actor has successfully exploited a security gap.

At S430, the quality of information included in each data source is determined. In an embodiment, the quality of information may be determined based on the level of detail and the relevance of the detail included in the information in each data source. For example, low-quality information in a data source may indicate missing fields in logs, inconsistent formats of logs, or logs that lack sufficient detail.

At S440, the identified missing data sources, identified security issues, and the determined quality of information are analyzed to determine security gaps. In an embodiment, analyzing identified missing data sources serves to indicate that a data source that was previously collected is no longer collected. This now-missing data source may indicate an uncovered deficiency (e.g. a security gap) in an organization’s security system that can be exploited. Analyzing the determined quality of information serves to indicate if any critical information is missing which in turn indicates at least a potential cyber-attack. Thus, a determined gap of missing critical information indicates a blind spot that can hinder the capability to identify a potential incident.

Analyzing the missing data sources, security issues, and data sources with low-quality information serve as indicators of a weakness in an organization’s security. A data source that was once collected but is now missing indicates a weakness that a threat actor can exploit. For example, an organization that used to collect logs from its firewall stopped doing so. Without the firewall logs, the organization loses visibility into incoming and outgoing network traffic, making it difficult to detect unauthorized access attempts or data exfiltration. A threat actor could exploit this weakness by launching attacks that go unnoticed due to the lack of firewall logs.

Additionally, a previous security issue may indicate where an organization has a weakness that is open to exploitation by a threat actor. For example, an organization experienced a phishing attack where employees were tricked into revealing their login credentials. Although the immediate threat was mitigated, the organization did not implement multi-factor authentication (MFA). This oversight left the organization open to future phishing attacks, as threat actors can exploit the same weakness to gain unauthorized access again.

Similarly, logs of low quality may indicate that an organization does not have a clear view of a potential attack. These examples illustrate a potential security gap and are used to determine such security gaps. A further example may be an organization’s intrusion detection system (IDS) generating logs that are incomplete or lack sufficient detail, such as missing timestamps or source IP addresses. These low-quality logs make it challenging to correlate events and identify patterns of malicious activity. As a result, the organization may not have a clear view of potential attacks, allowing threat actors to operate undetected within the network.

In an embodiment, the missing data sources, previous security issues identified, and the determined quality of information of data sources are used as inputs in an AI process. This AI process is discussed in more detail in S330, FIG. 3.

Although FIG. 4 shows example blocks of process S330, in some implementations, process S330 may include additional blocks, fewer blocks, different blocks, or differently arranged blocks than those depicted in FIG. 4. Additionally, or alternatively, two or more of the blocks of process S330 may be performed in parallel.

FIG. 5 is an example graph 500 of ranked recommendations for addressing security gaps in an organization’s security system. In an embodiment, the ranking of recommendations and generation of a graphical representation of ranked recommendations is performed by system 130.

The x-axis of the graph represents ease of implementation, and the y-axis represents security value. The top row represents the recommendations with the highest security value and the bottom row represents the recommendations with the lowest security value. The leftmost column represents the recommendations with the lowest ease of implementation (hardest) and the rightmost column represents the recommendations with the highest ease of implementation (easiest).

In the graph 500, there are two classes of recommendations: visibility recommendations (V1-V16) and storage recommendations (S1). A visibility recommendation is a suggestion to collect, ingest, examine, forward, or enable agents to examine data sources that were deemed to create a security gap in the organization’s security systems. A storage recommendation is a suggestion to, for example, store logs from a particular source. The number and type of recommendations should not be construed as limited to the recommendations illustrated in the graph 500.

In an embodiment, each recommendation is organized in a chart. In the chart, each recommendation is organized by ID, e.g., V3; name, e.g., ingest load balancer and WAF logs; domain, e.g., application; security value, e.g., 5 (very high); and ease of implementation, e.g., 4 (easy). Security values may range from very low, to low, medium, high, or very high, but are not limited to such a range. Ease of implementation may range from very easy, to easy, medium, hard, or very hard, but is not limited to such a range.

In a further embodiment, summaries explaining each recommendation are reported or otherwise provided to the user through, for example, user device 120.

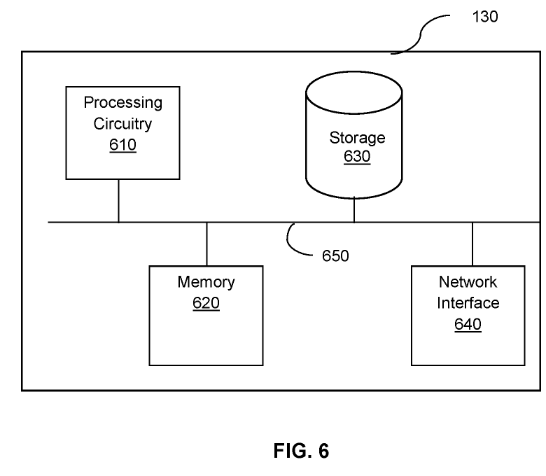

FIG. 6 is an example schematic diagram of a system 130 according to an embodiment. System 130 includes a processing circuitry 610 coupled to a memory 620, a storage 630, and a network interface 640. In an embodiment, the components of system 130 may be communicatively connected via bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), or any other hardware logic components that can perform calculations or other manipulations of information.

The memory 620 may be volatile (e.g., random access memory, etc.), non-volatile (e.g., read-only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read-only memory (CD-ROM), or any other medium that can be used to store the desired information.

The network interface 640 allows system 130 to communicate with other systems, devices, components, applications, or other hardware or software components, for example as described herein.

It should be understood that the embodiments described herein are not limited to the specific architecture illustrated in FIG. 6, and other architecture may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer-readable medium consisting of parts, or certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for identifying security gaps in a cybersecurity system, comprising:
retrieving a plurality of data sources from each of a plurality of data lakes, wherein the plurality of data sources includes data from a plurality of domains of an organization’s information technology infrastructure;
identifying security gaps in the cybersecurity system by analyzing the plurality of data sources, wherein security gaps indicate at least one uncovered deficiency in the cybersecurity system; and
generating at least one recommendation, wherein each recommendation is a suggestion to address a respective identified security gap.

2. The method of claim 1, further comprising:
connecting to the plurality of data lakes, wherein each data lake is a repository of raw data from the plurality of data sources.

3. The method of claim 2, wherein identifying the security gaps further comprises:
identifying at least one missing data source;
identifying security issues;
determining quality of data recorded in the plurality of data sources; and
analyzing the at least one missing data source, the identified security issues, and the determined quality of data to identify security gaps.

4. The method of claim 3, wherein identifying at least one missing data source further comprises:
comparing collected data sources of the plurality of data sources with historical data sources to determine at least one previously collected data source that is now missing wherein the determined missing data source indicates at least one uncovered deficiency that can be exploited.

5. The method of claim 3, wherein identifying the security issues further comprises:
analyzing patterns in historical data sources, wherein a security issue indicates a blind spot that hinders the capability to identify a potential incident.

6. The method of claim 3, wherein determining the quality of data further comprises:
analyzing the number of fields in a data log, the formats of different data logs, and the level of detail in the data logs to determine missing critical information that indicates at least a potential cyber-attack.

7. The method of claim 1, wherein collected data sources are data sources that are currently collected by an organization and stored in at least one data lake of the plurality of data lakes; and wherein historical data sources are data sources that previously were collected by an organization and stored in at least one data lake of the plurality of data lakes.

8. The method of claim 1, further comprising:
ranking the at least one recommendation, wherein each recommendation is ranked based on a security value and an ease-of-implementation value.

9. The method of claim 8, wherein the security value is a measure of how valuable a recommendation of the at least one recommendation is for cyber-security of an organization; and wherein the ease-of-implementation value is a measure of a facility, efficiency, cost, and time associated with implementation of a recommendation of the at least one recommendation.

10. The method of claim 1, wherein a domain of the plurality of domains is any one of: a network domain, a cloud domain, an identity domain, an application domain, and an endpoint domain.

11. A non-transitory computer-readable medium storing a set of instructions for identifying security gaps in a cybersecurity system, the set of instructions comprising:
one or more instructions that, when executed by one or more processors of a device, cause the device to:
retrieve a plurality of data sources from each of a plurality of data lakes, wherein the plurality of data sources includes data from a plurality of domains of an organization’s information technology infrastructure;
identify security gaps in the cybersecurity system by analyzing the plurality of data sources, wherein security gaps indicate at least one uncovered deficiency in the cybersecurity system; and
generate at least one recommendation, wherein each recommendation is a suggestion to address a respective identified security gap.

12. A system for identifying security gaps in a cybersecurity system comprising:
one or more processors configured to:
retrieve a plurality of data sources from each of a plurality of data lakes, wherein the plurality of data sources includes data from a plurality of domains of an organization’s information technology infrastructure;
identify security gaps in the cybersecurity system by analyzing the plurality of data sources, wherein security gaps indicate at least one uncovered deficiency in the cybersecurity system; and
generate at least one recommendation, wherein each recommendation is a suggestion to address a respective identified security gap.

13. The system of claim 11, wherein the one or more processors are further configured to:
connect to the plurality of data lakes, wherein each data lake is a repository of raw data from the plurality of data sources.

14. The system of claim 12, wherein the one or more processors, when identifying the security gaps, are configured to:
identify at least one missing data source;
identify security issues;
determine quality of data recorded in the plurality of data sources; and
analyze the at least one missing data source, the identified security issues, and the determined quality of data to identify security gaps.

15. The system of claim 13, wherein the one or more processors, when identifying at least one missing data source, are configured to:
compare collected data sources of the plurality of data sources with historical data sources to determine at least one previously collected data source that is now missing wherein the determined missing data source indicates at least one uncovered deficiency that can be exploited.

16. The system of claim 13, wherein the one or more processors, when identifying the security issues, are configured to:
analyze patterns in the historical data sources, wherein a security issue indicates a blind spot that hinders the capability to identify a potential incident.

17. The system of claim 13, wherein the one or more processors, when determining the quality of data, are configured to:
analyze the number of fields in a data log, the formats of different data logs, and the level of detail in the data logs to determine missing critical information that indicates at least a potential cyber-attack.

18. The system of claim 11, wherein collected data sources are data sources that are currently collected by an organization and stored in at least one data lake of the plurality of data lakes; and
wherein historical data sources are data sources that previously were collected by an organization and stored in at least one data lake of the plurality of data lakes.

19. The system of claim 11, wherein the one or more processors are further configured to:
rank the at least one recommendation, wherein each recommendation is ranked based on a security value and an ease-of-implementation value.

20. The system of claim 18, wherein the security value is a measure of how valuable a recommendation of the at least one recommendation is for the cyber-security of an organization; and
wherein the ease-of-implementation value is a measure of the facility, efficiency, cost, and time associated with implementation of a recommendation of the at least one recommendation.

21. The system of claim 11, wherein a domain of the plurality of domains is any one of:
a network domain, a cloud domain, an identity domain, an application domain, and an endpoint domain.
